(19) United States
(12) Patent Application Publication
(10) Pub. No.: US 2012/0095897 A1
(43) Pub. Date: Apr. 19, 2012

(54) SYSTEM AND METHOD FOR TRADING OF CARBON UNITS

(76) Inventor: Justin Barrow, London (GB)

(21) Appl. No.: 12/905,747

(22) Filed: Oct. 15, 2010

(51) Int. Cl. G06Q 40/00; G06Q 99/00

(52) U.S. Cl. 705/37; 705/317

(57) ABSTRACT

A carbon credit trading system, comprising a server having an input for receiving information indicating a user's carbon usage; a payment calculator module comprising a processor and memory configured for calculating and outputting a value indicating a cost of a selected portion of the user's carbon usage, an output for sending the calculated value to the user for approval; a user input for receiving approval of the calculated value or receiving further information from the user indicating an alternative selected proportion of the carbon usage that the user will pay; and a payment module for initiating billing of the user after receiving the user's approval.

### BACKGROUND OF THE INVENTION

1. Field of the Invention

The present invention relates to a system and method for trading of carbon units.

2. Description of the Related Art

In recent years, public awareness of climate change and the impact of excess greenhouse gas emissions on the environment have been increasing. Greenhouse gas emissions are created directly as a result of the burning of fossil fuels, required in air travel, car or rail journeys, and for electricity or gas consumption. Also, everyday products and activities have associated carbon emissions, e.g. as a result of associated manufacturing processes. The idea of trading of carbon units (“carbon credits”) to reduce overall emissions was introduced under the Kyoto Protocol, which was adopted in Kyoto, Japan in 1997, and came into force in 2005. A carbon unit is equal to one metric tonne of carbon dioxide equivalent (tCO₂e) removed from the environment. Entities running low carbon-emissions or emissions free power generation or industrial processes may be eligible to receive carbon units, which they can sell on to entities (e.g. manufacturers, power companies, etc) who are emitting more than their quota of carbon dioxide in order to offset these excess emissions.

There are two types of carbon units available. A Certified Emission Reduction (CER) is a carbon unit traded within the compliance market, in which entities are legally obliged to meet certain carbon dioxide emission quotas. A Verified Emission Reduction (VER) is a carbon unit traded in the voluntary market, which is proving to be very popular with entities looking to be seen as environmentally friendly.

Within the compliance market, carbon unit trading is regulated and monitored by the United Nations Framework Convention on Climate Change (UNFCCC). Companies have caps placed on the amount of carbon they can release, according to their amount of business. If they exceed the cap, they have to buy carbon emission reductions from the market to compensate. In recent years, the caps have been continually getting tighter, and this trend is expected to continue. The main market for CERs is the European Union Emissions Trading Scheme (EU ETS). A large proportion of carbon units are sold into the market developed from projects in countries such as China, India and Brazil. Carbon units are awarded to carbon projects which meet particular standards, and are registered under the United Nations Clean Development Mechanism (CDM) process. For example, a wind farm or a gas emission reduction scheme applied to a coal mine may be registered to generate carbon credits.

The voluntary carbon market works in a different way, and is not monitored by the

United Nations, but by independent standards, such as the Gold Standard, Plan Vivo, Social Carbon and the Voluntary Carbon Standard (VCS); and registries, operated by commercial market participants, such as Markit, who manage and operate the Markit Environmental Registry. The voluntary market has a different set of pricings from the compliance market. Similar to the compliance market, the different standards and different projects within the voluntary market also have different pricings. The voluntary market tends to operate via brokers or project developers, who assist projects owners in the generation and registration of carbon units; and then assist them to sell the carbon units. Each project only has a certain number of available emission reductions, according to its size, scale and type, and the associated amount of energy generated.

Each verified emission reduction (VER) is issued with an ID number by the relevant standard when the carbon unit is issued. A registry keeps track of the carbon units created and sold, and individual brokers have either direct accounts with the registry or deal with the registry through an intermediary and may have a sub-account on the registry. A registry will retire carbon units after they have been purchased to offset against a carbon emission and can only retire whole carbon units, the minimum being a one tonne carbon unit retirement. It is also possible for an entity buying carbon units to sell them onto another entity, rather than offsetting them against an emission and having them retired.

A project owner is the entity owning and developing a carbon emission reduction project. A project developer is an entity which typically provides technical and financial services to the project owner to develop the carbon unit according to the rules and regulations set out within either the compliance or voluntary markets. A project developer typically does not normally receive a payment for helping to register a project to receive carbon credits, but instead receives a percentage of the carbon credits developed by the project each year, which can be sold on to customers. A project developer may also help the project owner sell their own VERs for a percentage commission.

A carbon broker or retailer typically buys blocks of carbon units at a time from a project developer, e.g. 5,000 units. The units may be purchased before the retailer sells them on to a consumer. Alternatively, the retailer may sell carbon units to a consumer before the units have been purchased from a project developer. Either way, as soon as a consumer has purchased a carbon unit from a retailer, the retailer will be required to retire the issued carbon unit for and on behalf of the consumer. Consumers would typically be told whether the carbon credits have actually been issued yet, and if not, then when they are expected to be issued. Live tracking information for the project may be provided to consumers.

When carbon credits are issued, each carbon credit has a unique ID code, e.g. a number or alphanumeric sequence, which is allocated under the standard. Once the carbon unit has been purchased by the user, the retailer will retire the carbon unit on the registry and the registry can send a retirement certificate to the customer to indicate that the credits have been retired and can not be re-sold. This process is to avoid double counting and commercial fraud in the buying and selling of carbon units.

A purchaser wishing to buy carbon units may do so by contacting a broker directly, or by buying from one of the many online retail websites that are selling carbon units. Online retail sales of carbon units are typically linked to a particular carbon offset purpose, e.g. flights, road travel, etc. Various tools are available via the internet for calculating carbon units for different purposes. Such tools calculate the total amount of carbon emissions created by the daily activity (e.g. the amount of carbon emissions produced by a flight between two specified locations), and allow a user to purchase a corresponding number of carbon units to offset the calculated carbon emissions. For example, the tools would calculate and output a number in tonnes of carbon dioxide equivalent (tCO2e) based on information provided by a customer, give a price to the customer for offsetting this amount of carbon emissions and allow the customer the option to buy the carbon units or not.

A large number of carbon calculators currently exist on the internet, and the amount of detail required and data quality used in calculating the carbon offset is very variable between different carbon calculators. The carbon unit calculations may be performed using research data based on known amounts of carbon dioxide emissions and known variations according to different carbon emission factors, to allow accurate carbon estimates to be determined. The research data may be derived or obtained from external sources, e.g. government agencies, specialist companies, etc. Typically, carbon calculators will calculate the carbon emissions for items such as flights, car trips, home electricity use, and businesses office utility bills. A carbon unit calculator for flights typically requires the user to input the airports at the start and end of the journey, calculates the number of air miles, calculates the resulting carbon emissions which indicates the number of carbon offsets required. A carbon unit calculator for car journeys may simply input factors such as distance driven, fuel consumption (e.g. miles per gallon) and fuel type, or it may perform a more sophisticated calculation based on the type of car, and other factors.

### SUMMARY OF THE INVENTION

One aspect of the present invention provides a system and method for trading of carbon units which allows a much greater degree of flexibility than previously known systems. The system may enable a much larger number of consumers to become involved in carbon offsetting, by allowing consumers to choose to redeem only a part of their carbon emissions, and as a result making the purchase of carbon units more affordable.

One embodiment of the invention provides a software application that operates with an existing carbon unit retailer's website, to allow customers to pay a selected proportion of the cost that is normally charged for a quantity of carbon units. In another embodiment, a corporate account is enabled, wherein a company pays a percentage share of the carbon units and the customer also pays a percentage share, which may or may not add up to the total cost of the carbon units.

In a further aspect of the invention, a system and method for aggregated purchase of carbon units is provided. The aggregated purchase may occur via text messaging, emails, or some other means. The aggregation may be implemented at a single level, or at a number of different levels.

In a yet further aspect of the invention, carbon units are linked to other consumer products, e.g. software, digital files, or any other type of goods or services. In one embodiment, the carbon units are linked to virtual purchases in virtual worlds. For example, carbon units may be embedded in virtual products, and automatically supplied when the virtual products are purchased. In some virtual world games, particular products for sale to a user may be linked to success in the game. A virtual world game could be configured so that users had to buy certain carbon unit-linked items to progress a certain distance in the game. This would drive the purchase of specific carbon-linked products. It will be appreciated that a carbon footprint associated within a virtual world activity, event or product may or may not have a real world equivalent. The carbon footprint associated with the virtual world activity, event or product may, for example by such that it offsets a carbon footprint of computing equipment/servers used for generating/running the virtual world, so that the generation and operation of the virtual world goes some way towards becoming carbon neutral, or even becomes carbon neutral, through the participation of players in virtual world events, activities of through virtual world purchases. This is, however, not to say that the carbon footprint defined in the virtual world has to be associated with a real world carbon footprint. Instead the carbon footprint defined in the virtual world and associated in the virtual world with an activity, event and/or purchase, etc. may simply make a contribution to the purchase of real world carbon credits to facilitate reduction of CO₂ in the atmosphere.

It is not essential to use desktop or laptop computers to perform the invention, and other computer devices such as mobile phones, PDAs, netbooks, etc could all be used instead.

### BRIEF DESCRIPTION OF THE DRAWINGS

Embodiments of the present invention will now be described, by way of example only, with reference to the accompanying drawings, in which:

FIG. 1 shows a schematic diagram of a computer network for carbon trading;

FIG. 2 shows a block diagram of a presently known carbon unit trading system;

FIG. 3 shows a block diagram of a carbon unit registry system;

FIG. 4 is a block diagram of a system according to an embodiment of the invention;

FIG. 5 shows a flow chart of a process according to an embodiment of the invention;

FIG. 6 shows a block diagram of a carbon unit aggregation system, according to an embodiment of the invention;

FIG. 7 shows a block diagram of a virtual world trading system in an embodiment of the invention;

FIG. 8A to D show a distributed carbon calculation embodiment;

FIG. 9 shows a flow chart of the steps of the method illustrated in FIGS. 8A to D performed in a user's computer according to one embodiment; and

FIG. 10 shows a user's computer capable of implementing the method illustrated in FIG. 9;

FIG. 11 shows a flow chart of the steps of the method illustrated in FIGS. 8A to D performed in a carbon retailer's server according to one embodiment;

FIG. 12 carbon retailer's server capable of implementing the method illustrated in FIG. 9;

FIG. 13 shows a flowchart of a carbon project selection method performed in a user's computer;

FIG. 14 shows a flowchart of a carbon project selection method performed in a carbon retailer's computer; and

FIG. 15 shows a carbon unit purchasing system in which the carbon units purchased are associated with an action occurring in a virtual world.

### DETAILED DESCRIPTION OF THE PREFERRED EMBODIMENTS

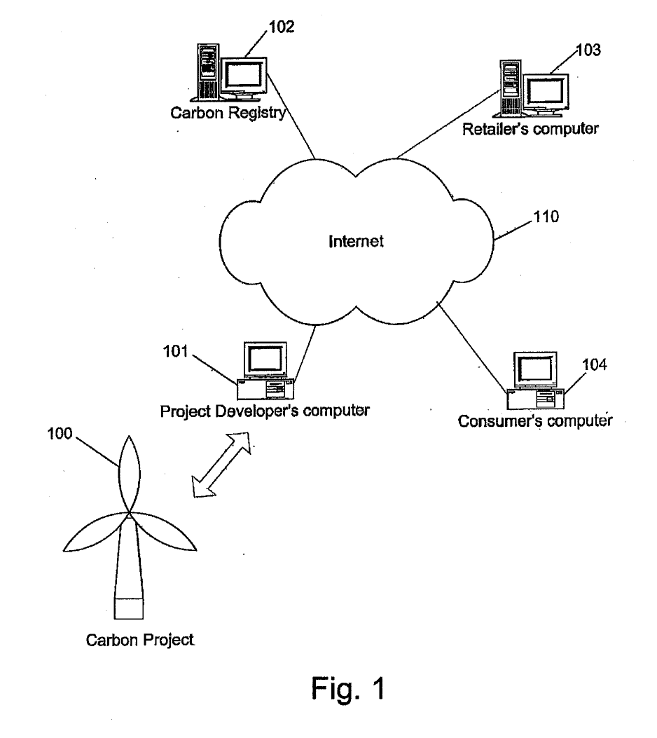

FIG. 1 is a schematic diagram of a computer network for trading of carbon credits. A carbon project 100, such as a wind farm, generates energy with low or zero carbon emissions. A project developer 101 works with the owners of the carbon project 100 to have it registered by a carbon credits registry 102 and awarded with carbon credits, e.g. a specific number of carbon credits per year or per month or some other time period, according to the amount of carbon emissions that may be offset by the project. The project developer typically gets to keep and sell a proportion of the carbon credits, and may also sell the carbon credits owned by the project 100 in exchange for a commission. The project developer's computer 101 and the carbon registry 102 are connected via network 110, such as the internet. A carbon broker or retailer's computer 103 is also connected to the internet, and the carbon broker or retailer may purchase carbon units and sell them onto consumers or to further brokers. A consumer's computer 104 is also shown as connected to the network, and the consumer may buy carbon units from a broker or retailer 103 (e.g. via a website).

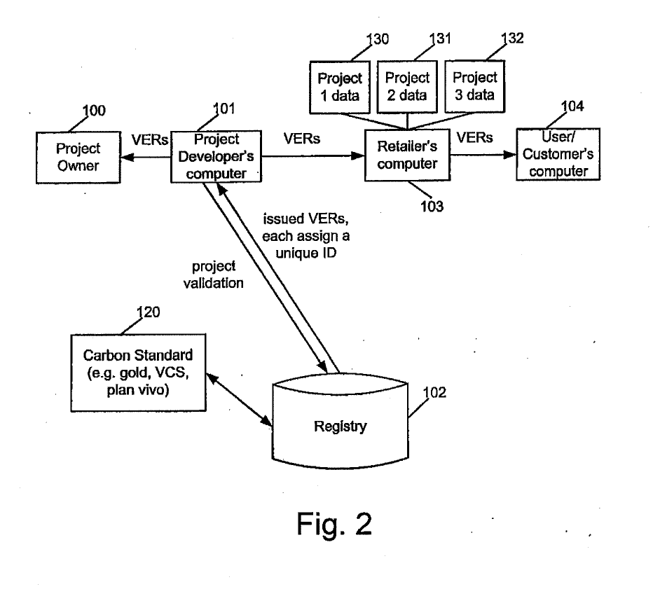

FIG. 2 is a block diagram of a voluntary carbon unit trading system arrangement. A registry 102 is responsible for issuing carbon units (VERs) to projects that are validated by a carbon standard 120, such as the Gold Standard, VCS or Plan Vivo. A project developer 101 works with project owners 100 to have the project approved under the selected standard 120, and the carbon units are issued by the registry 102. The issued carbon units each have a unique ID code, so that they can be traced through subsequent transactions. The project developer 101 typically retains a proportion of the carbon units in payment for their services. They may sell these on to carbon retailers 103, who in turn sell them to end customers 104. The project developer 101 may also sell the carbon units belonging to the project owner 100, e.g. in return for a commission on the sale.

The retailer 103 will typically buy and sell carbon units for a number of different carbon projects. In this example, the retailer 103 stores data relating to three separate carbon projects, 130, 131, 132. One of these sets of project data corresponds to the project 100, and the other two relate to two other projects. The retailer 103 will typically provide marketing data to customers about each of the carbon projects 130, 131, 132, for instance, showing videos, text and photographs via a website, to provide the consumers with more information about what is involved in the project setup.

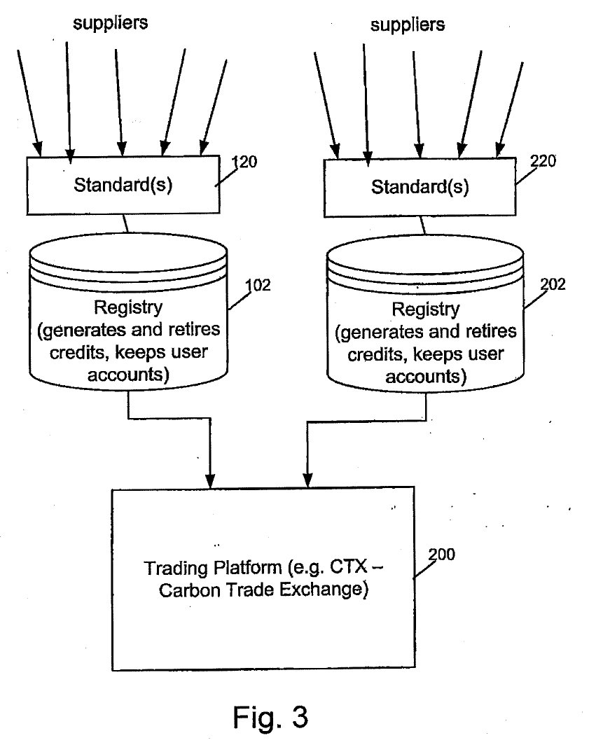

FIG. 3 is a schematic diagram showing how different carbon registries interact in global trading of carbon units. A first registry 102 is shown, associated with a first carbon unit standard 120. A number of suppliers will have had their projects approved under the standard, and a number of carbon credits for each project will be approved over a time period. The registry then generates the carbon credits, keeping a record of the unique ID code for each credit, and the current owner of each of the credits. Each supplier has an account or a sub-account on the registry which they can check to see how many carbon credits they have. It is not essential for the suppliers to be sent a list of the carbon credit ID codes, because this information is stored on the registry.

A second registry 202 is also shown, associated with a second standard 220. This may be the same as the first standard, or may be different. The registries may be located in different geographic locations, dealing with different populations and currencies, although in some cases, a supplier may have an account on more than one registry. Each registry may operate with more than one standard, keeping records for each resulting type of carbon credit.

The two registries 102, 202 are shown as connected to a trading platform, such as the Carbon Trade Exchange (CTX). The trading platform allows an account holder of a first registry to buy types of carbon credits that are not available directly from that registry.

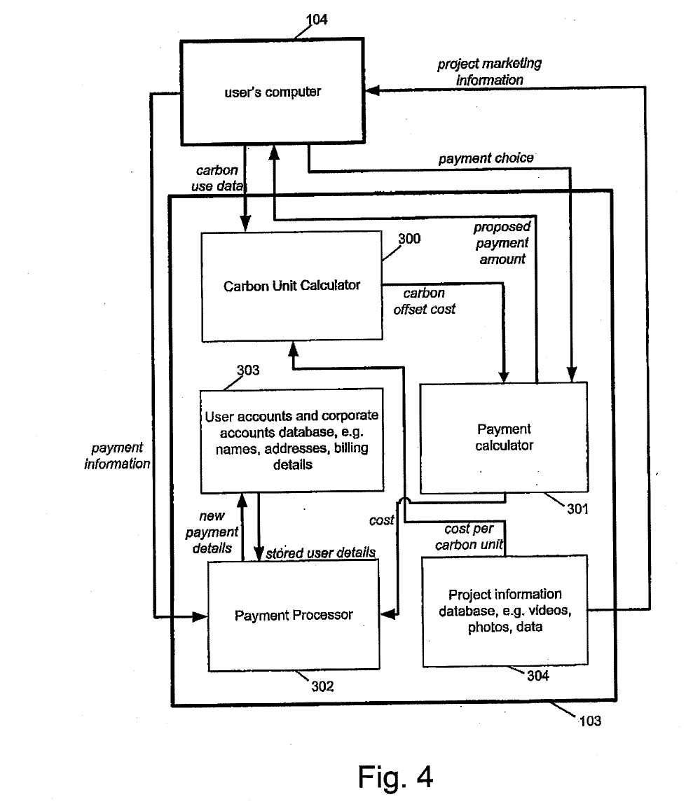

FIG. 4 shows a system for carbon unit purchasing according to an embodiment of the invention. A user's computer 104 communicates with a retailer's computer 103 to make a carbon offset purchase. Although this example refers to a user's computer 104, this could be a mobile phone, a PDA (personal digital assistant), a netbook, or some other computing device with a suitable network connection. In this example, the retailer's computer 103 comprises a carbon unit calculator 300, a payment calculator 301, a payment processor 302, a database 303 for user accounts and corporate accounts, and a project information database 304. These modules may be implemented as separate hardware modules, or they may be implemented as a number of different software modules sharing common hardware elements, or a combination of the two.

The database 303 for user accounts and corporate accounts stores user profile information and information on companies with corporate accounts, such as name, address, date of account creation, date of birth, email address (to send confirmation information), and payment details. In some embodiments, the corporate accounts data is not required. In some embodiments, each user has their own unique user account, and in other embodiments, a user may not be required to login, and there may be no need to generate and store user accounts.

The project information database 304 stores details on individual carbon projects, e.g. photos, videos and data. The project information database 304 may be part of the same storage device as the user accounts database 303 or it may be on a separate storage device, which may be located remotely and accessed via a network connection, e.g. directly from a project developer's website.

The retailer's computer 103 may be configured as a web server, to allow users (e.g. customers) to connect, register, select carbon credits for purchase, and pay. Alternatively, other configurations are also possible, e.g. to enable communications between the user's computer 104 and the retailer's computer 103 by text message, email, or some other means.

When a user's computer 104 connects with the retailer's computer 103, the user's computer 104 may request and receive project information from the project information database 304, e.g. video clips, photos and text describing one or more projects. The user may choose which project to support. The user enters their carbon usage data, which may include details of one or more flights, car journeys, train journeys, household or office emissions, etc. This information goes to the carbon unit calculator 300 in the retailer's computer, which uses the information provided by the user together with previously stored information or parameters on carbon emissions, to calculate a carbon offset value. Different projects may have different costs per carbon credit, and this information may be provided from the project information database 304 to the carbon unit calculator 300, which then converts the carbon offset value to a price.

The price is transmitted to a payment scaling calculator 301, which allows the user to choose to pay only a certain proportion of this price. The payment scaling calculator sends a proposed payment amount to the user's computer 104, which may initially be 100% of the total carbon offset price. In return, the payment scaling calculator receives a payment choice from the user. This may be to pay the proposed amount, or it may be to modify the proposed amount, e.g. by increasing or decreasing it. In one embodiment, the payment scaling calculator 301 may allow a user to nominate any percentage value they choose, and then to accept this as the amount of money that will be paid. In other embodiments, the payment scaling calculator 301 may only allow specific values, e.g. the payment may only be above a minimum threshold, either in terms of percentage or in absolute terms (e.g. to prevent the payment processing costs from exceeding the money received). In a further example, only discrete amounts or proportions of the total amount may be offered to the user or accepted by the payment scaling calculator, e.g. all payments may be rounded up to the nearest acceptable value.

The accept cost, agreed by the user's computer 104, is sent to the payment processor 302, where the user's payment is processed. The payment processor may accept payment information directly from the user's computer, or it may retrieve previously stored payment information for that user from the user accounts database 303. The payment is then processed by standard means, such as a credit card transaction, PayPal, etc. In some embodiments, the payment processor may be located on a separate computer than the retailer's computer 103, and the payment information may be transmitted over a secure network connection.

In some embodiments of the invention, an existing retailer's website may be modified to implement an embodiment of the invention. For example, on a website that previously was configured to calculate a carbon offset and allow the user to purchase that carbon offset, the website may be modified by adding the payment scaling calculator 301, and by adapting the functionality so that the user has an opportunity to choose to amend the payment by paying only a certain proportion of the actual cost of the carbon offset.

In some embodiments, a contribution to the payment may also be made through a corporate account. For example, a company may have a number of employees engaged in regular air travel. The company may make a contribution of a certain percentage cost towards the carbon credits for that air travel, while allowing the individual employees the opportunity to also make a contribution. In one example, the company may match the contribution of the employee, e.g. up to a maximum limit. In another example, the company may pay a fixed proportion of the carbon credits, regardless of whether or not the employee decides to contribute. Many other alternative arrangements are also possible, which may be dependent on the employee contribution or not. The employee and the company may be billed separately, or one of them may be billed for the full cost, to claim back later from the other.

After a payment is processed for a number of carbon units, these carbon units may be retired by the carbon registry. For example, if the user purchases only a fraction of a single carbon unit, it will be necessary to accumulate a number of such transactions before the carbon units can be retired.

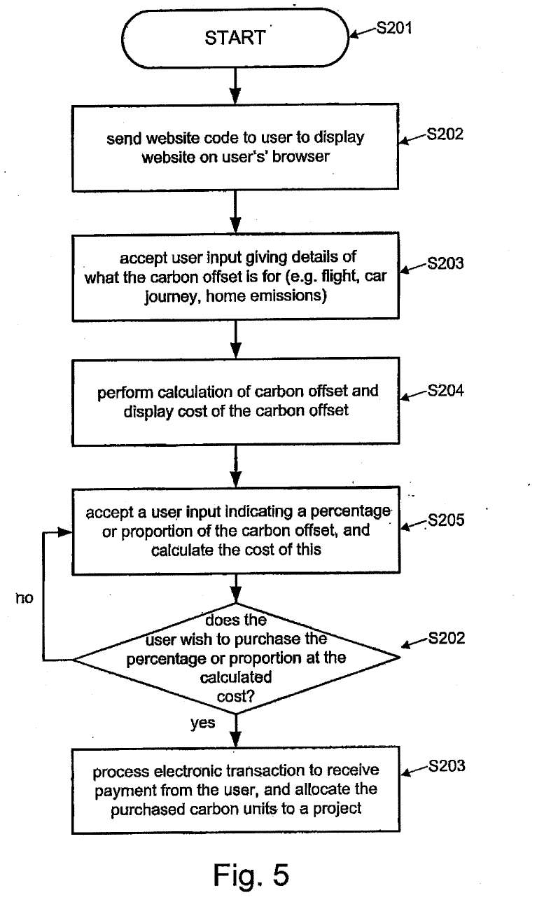

FIG. 5 is a flowchart showing a process implemented by a carbon retailer's computer according to an embodiment of the invention. The process starts at step S201. At the next step, S202, a carbon retailer's computer sends code to a customer's computer to make it display a website selling carbon credits. The website may include marketing material such as information, photos and/or a video of the carbon project. The project information may include information about the project type, partner, location, carbon standard, project status, portfolio, and relevant documents.

At step S203, the carbon retailer's server receives data from the customer, giving details of what the carbon offset is for. This allows the carbon footprint to be calculated, which occurs at step S204.

The website may include an in-built carbon calculator, or it may be linked to a carbon calculator via a network connection. In some embodiments, an existing carbon vender's method may be used to calculate the number of carbon units, and additional code may be provided to convert this existing system to an embodiment of the present invention.

After calculating the carbon offset, and displaying this on the consumer's computer, at step S205, the consumer is given an opportunity to indicate or modify a percentage or proportion of the carbon cost that they wish to pay. The new modified cost is re-calculated at step S206, and if the consumer approves the bill, the process continues to step S207. If the consumer does not approve the bill, the process goes back to step S205.

At step S207, an electronic transaction is processed to receive the payment from the user and then the purchased carbon units can be allocated to the selected project. Standard online payment methods may be used to pay for the carbon credits, e.g. credit cards, debit cards, PayPal, etc. In some embodiments, a user may be required to login before purchasing carbon credits, but in other embodiments, this is not necessary. The server may store and monitor the number of carbon units in stock from each project, and/or the number of carbon units that have been bought. Carbon units may be retired when the purchased amounts from one or more customers adds up to at least a whole carbon unit. In some cases, it is more preferable to retire the carbon units in blocks. However, if a number of consumers are each buying only a fraction of a carbon unit, then an aggregation of the purchased fractions of units can be performed, before the units can be retired.

In other aspects of the invention, small fractions of carbon units are deliberately sold to a large number of users, and the fractions of carbon units are aggregated to allow a broker to purchase and then retire whole carbon units.

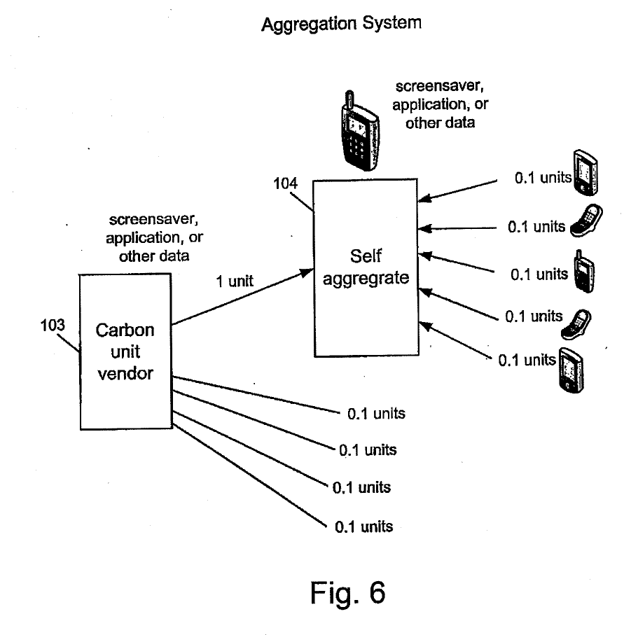

For example, FIG. 6 shows a carbon unit aggregation system according to an embodiment of the invention. A carbon unit retailer 103 sells a carbon unit or a fraction of a carbon unit to a number of customers 104 along with an electronic software application or electronic data, such as a screensaver or a music file. The retailer may aggregate fractional purchases by users, to allow whole carbon units to be bought and retired. The retailer may also allow at least some of the customers to further distribute the electronic product (e.g. screensaver, music file, etc) along with fractional parts of the carbon unit or carbon unit portion that each of these customers has purchased.

Thus, the customer sells on fractions of the carbon unit to their own contacts, e.g. friends, family, colleagues, etc. The customer's computing device (e.g. a mobile phone in one example) aggregates the carbon unit fractions and aggregates the payments, so that the customer makes back their initial investment to the carbon retailer 103. Any extra payment over and above 100% of what the customer paid may result in extra money being paid to the customer's account, or the extra money being used to purchase additional voluntary carbon credits, or a combination of these two.

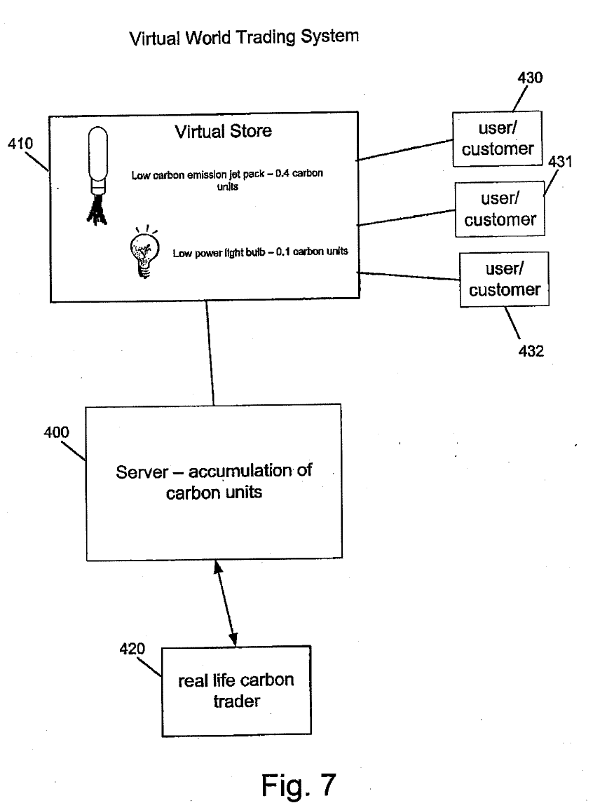

FIG. 7 shows a virtual gaming store according to an embodiment of the invention. The store contains virtual products that are linked to carbon credits. For example, a carbon-efficient jet pack and a low power light bulb are shown. The user buys products using a currency of the virtual world, which corresponds to real money when this virtual currency has to be purchased. The user receives not only the virtual product but a small fraction of a carbon unit as well. Because the user is buying only a small part of a carbon unit, the cost becomes affordable in the context of the game. In the real world, a single carbon credit in the voluntary market typically costs somewhere around 10 to 25 US dollars. This is generally too much money for users of an online game to keep paying for virtual items. However, by selling small fractions of a carbon unit with the virtual product, it is possible to keep the pricing within an affordable level, and to cumulatively sell a lot more carbon credits than would otherwise be possible.

The present invention can be implemented in dedicated hardware, using a programmable digital controller suitably programmed, or using a combination of hardware and software.

Alternatively, the present invention can be implemented by software or programmable computing apparatus. This includes any computer, including PDAs (personal digital assistants), mobile phones, etc. The code for each process in the methods according to the invention may be modular, or may be arranged in an alternative way to perform the same function. The methods and apparatus according to the invention are applicable to any computer with a network connection.

Thus the present invention encompasses a carrier medium carrying machine readable instructions or computer code for controlling a programmable controller, computer or number of computers as the apparatus of the invention. The carrier medium can comprise any storage medium such as a floppy disk, CD ROM, DVD ROM, hard disk, magnetic tape, or programmable memory device, or a transient medium such as an electrical, optical, microwave, RF, electromagnetic, magnetic or acoustical signal. An example of such a signal is an encoded signal carrying a computer code over a communications network, e.g. a TCP/IP signal carrying computer code over an IP network such as the Internet, an intranet, or a local area network.

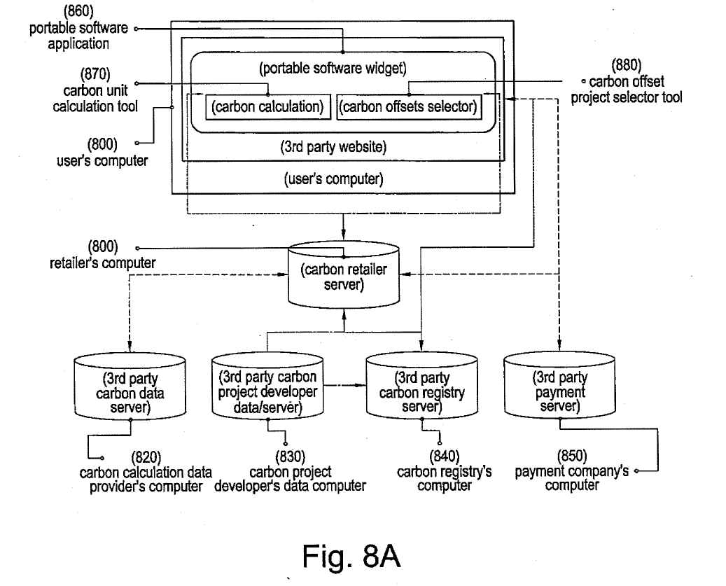

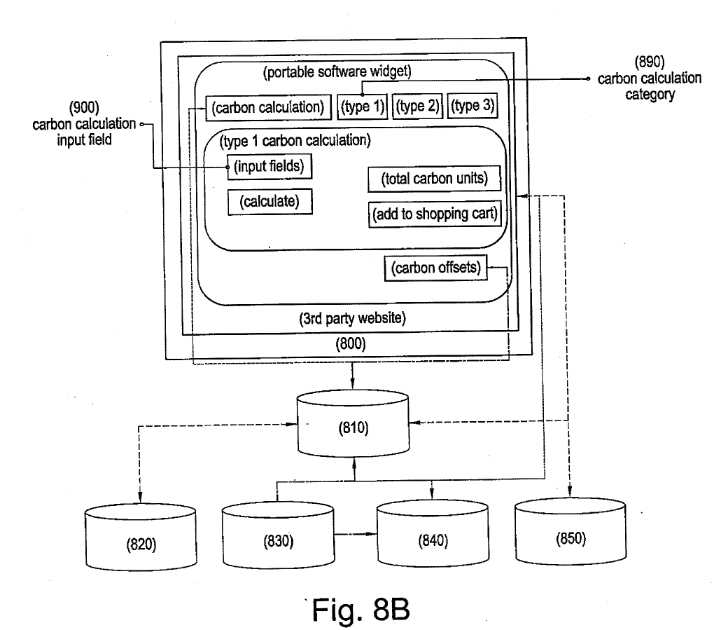

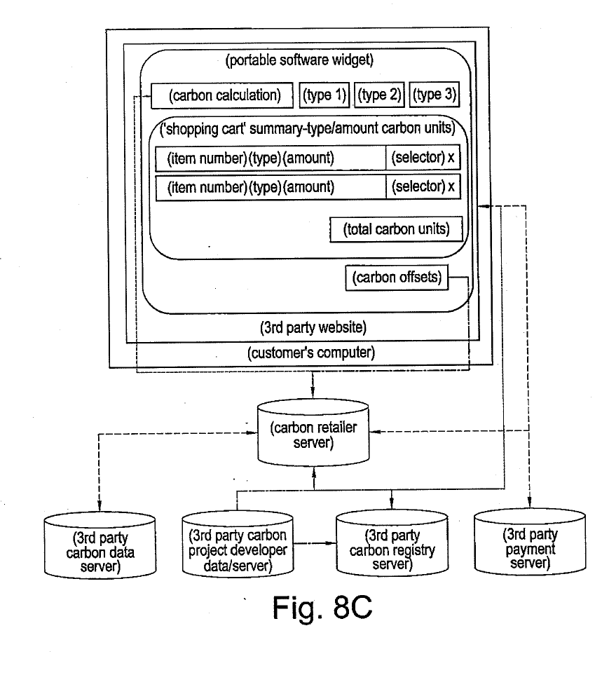

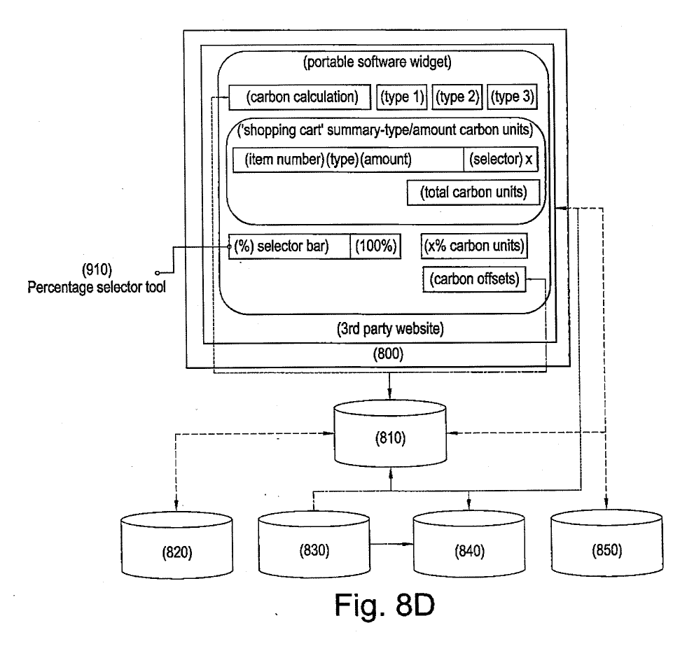

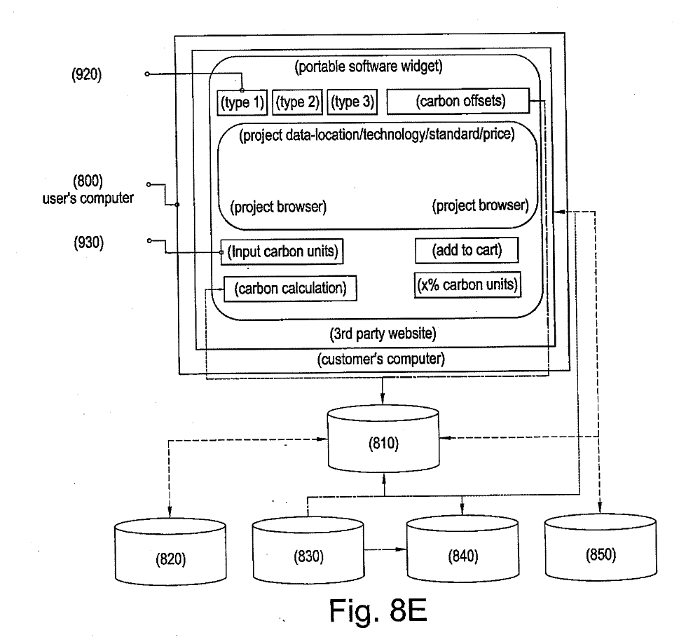

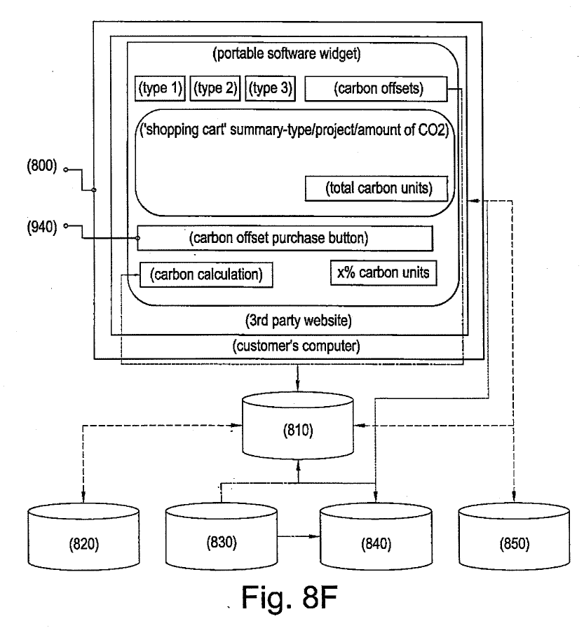

FIGS. 8A to F show a distributed system for carbon offsetting. The system operates on a number of interacting hardware devices, in this case the computer 800 of a user, a carbon retail server/computer 810, a carbon data server 820, a carbon project developer's data computer 830, a carbon registry server 840 and a payment server 850. As indicated in FIG. 8A, all of the components of the system can be operated by independent parties, although this is not essential. The user's computer may be any device with sufficient computing power for performing the functions described below. The user computer 800 may, for example, be a mobile phone, a personal digital assistant (PDA), a notebook or some other computing device with a suitable network connection, including of course laptops and desktop computers.

The server/computer 810 permits access to the carbon retail service by providing software module 860, accessible via a network, such as the internet, for this purpose. This software module 860 may be provided in the form of a portable software module that can be included in 3^{rd} party websites 870 (as shown), to facilitate distribution to a large number of potential users and to remove the burden of having to visit specific carbon offsetting websites from the user. It will, however, be appreciated that the software module 860 could equally well occupy its own website.

The software module 860 causes the display of a user interface on the user's computer 800. This user interface may, as shown, comprise a function 870 that allows the calculation of the carbon footprint of one or more particular actions, purchases or events, etc. for which a user may wish to buy carbon units. The user interface also provides access to a function 880 that allows the user to either select a proportion of the calculated carbon footprint that is to be offset or to select a particular carbon offset project from which the calculated/selected carbon units are to be purchased. Both of these functions may be provided in combination by the selector 880. It will be appreciated that, while FIG. 8A shows functions 870 and 880 presented to a user alongside each other, such presentation is not essential and the two functions may be presented to the user in a sequential fashion, so that, for example access to the carbon offset selector 880 is granted to the user once the carbon footprint of the activities/events/purchases has been calculated using the function 870.

In the following the interactions between the relevant components of the system shown in FIG. 8A following the activation by the user of the carbon calculation function 870 is discussed with reference to FIG. 8B. The user's computer 800 sends a message to the carbon retailer's computer 810 indicating activation of the function 870. The carbon retailer server 870 in turn sends computer code for altering the display on the user's computer 800, so that the user is presented, via the displayed user interface, with a number of input fields. In the non-limiting example shown in FIG. 8B the user is presented with selector buttons 890 that allow the selection of a carbon calculation type. The calculation types can include calculating the carbon footprint of home living, air travel and ground travel, etc. The different categories may be distinguished from each other through the type and amount of input required from the user for the calculation of the carbon foot print of the activity, purchase or event, so that the activation of different categories cause the carbon retailer server 810 to send different software code for the different types, depending on the type chosen, to enable the user's computer 800 to display different user interfaces for the different types of calculation. It will be appreciated that the carbon retailer server 810 may alternatively send all of the computer code required for the display of different interfaces for different calculation types as soon as the function 870 shown in FIG. 8A has been activated.

A user interface for a type 1 carbon calculation is shown in FIG. 8B. The user interface provides input fields 900 through which the user can input an activity, purchase, or event, etc. for which he or she may wish to purchase carbon units. The interface may, for example, be configured to permit the user to select a particular mode of ground transport, e.g. train or car, and to also provide an indication of the distance and/or route travelled. The number of carbon units required to offset 100% of the activity, event or purchase, etc. is then calculated and displayed to the user. The input of the relevant data through the user interface may be performed in stages, with the user interface changing as and if required from stage to stage. It can, for example, be envisaged that a user may select a particular ground transportation means used but does not know the distance travelled. The user interface may provide an input for inputting the start and end points of the journey alongside waypoints, if applicable or desired. Any information input in this fashion may then be sent to a 3^{rd} party server, either the server 820 or another suitable server, for calculation of the missing parameter, in this example distance. It will be appreciated that this example does not only apply to ground travel but to other forms of travel, such as air travel, as well as to any other activities, purchases or events for which 3^{rd} party information may be required to facilitate a sufficiently detailed input of the parameters surrounding the event/action/purchase or where a fine level of detail of the input is generally desired.

Information input through the interface is then transmitted in a known fashion from software application 860 through the user's computer to the carbon retailer's server 810 and on to the carbon data server 820. The carbon data server 820 uses the data received to retrieve, from a database, the carbon footprint of a unit of the event, activity or purchase, say of a travelled air mile, or of a mile travelled on the road or by rail, and transmits the unit carbon footprint back to the carbon retailer server. This unit footprint can then either be transmitted further to the software application 860 for the calculation of the total footprint of the activity/event/purchase selected by the user or, preferably, is used within the server 820 to calculate the total footprint. The latter alternative is more tamper resistant. If the latter alternative is implemented the carbon retailer's server transmits a message to the software application 860 including the total carbon footprint, so that the total carbon footprint can then be displayed by the software application 860, as shown in FIG. 8B.

As indicated in FIG. 8B, the user is given the option to add the total number of carbon units calculated in the above described fashion to a shopping cart. In other words, the user is given the option to either proceed with purchasing carbon units of the input data or to proceed to enter details of another activity, event or purchase etc.

The use of 3^{rd} party carbon data servers 820 allows the independent and trustworthy calculation of the total carbon footprint. Several 3^{rd} party carbon servers 820 may be used to allow verification of either the above discussed unit footprint or the total calculated footprint.

FIG. 8C shows a further user interface part provided by the software application 860. In FIG. 8C a user interface is displayed showing a list of all of the activities, purchases or events, etc. that the user had previously input data on and provides an indication of the total carbon footprint of all of the input events, activities and purchases. The user computer 800 may be configured by the software application 860 to retain the relevant individual footprints of the entered activities, events or purchase in a local memory, say in the local cache, to allow the summary display shown in FIG. 8C. Alternatively the relevant data may be stored on the carbon retailer's sever 820 and transmitted to the user's computer 800 for display. The user interface displayed by the software function 860 also provides the user with selector icons that allow the user to select or deselect certain ones of the previously entered events, actions or purchases, so that they may be included in or excluded from the total carbon unit purchase.

It will be appreciated from the above that the above described system allows the consumer to browse multiple carbon calculation categories and input and request multiple, different and independently served carbon calculations. At the end of each carbon calculation the total number of carbon units will be displayed and the user can choose to add or not to add these carbon units to the total carbon footprint for which carbon offset units are to be purchased.

FIG. 8D shows a next step of the carbon unit calculation provided by the software function 860. As can be seen from FIG. 8D, the total selected carbon footprint is displayed by the user interface, alongside a selector tool 910 enabling the user to select a percentage of the displayed total carbon footprint that is to be offset through the purchase of carbon units. This tool 910 may take the form of a slider bar that allows selection of the percentage by ‘dragging and dropping’, or the like, of a slider bar icon. The selected offset percentage may be displayed separately on or alongside the slider bar. Alternatively, a field for the numerical input of the percentage may be provided. The input percentage is then used to calculate the total number of carbon units that are to be purchased, as shown in FIG. 8D.

In the above discussion the carbon data server 820 provides unit carbon footprint data that enables either of the carbon retailer server 810 and the software function 860 to calculate the carbon footprint of individual activities, events or purchases, etc., the total carbon footprint of all activities, events and purchases entered by the user and a desired percentage of this total, as indicated by the user. In another embodiment the carbon data server 820 may be arranged to perform some or all of these calculations itself, so that the carbon retailer's server 820 functions as a conduit for the exchange of messages between the carbon data server 820 and the software function 860.

Providing the user with a means for adjusting the percentage of the total entered carbon footprint that is to be offset through the purchase of carbon units can render it affordable for uses to offset at least some of the carbon footprint, whereas otherwise the user may not have offset any of their carbon footprint at all. Limited affordability to offset may further motivate a user to limit their future carbon footprint.

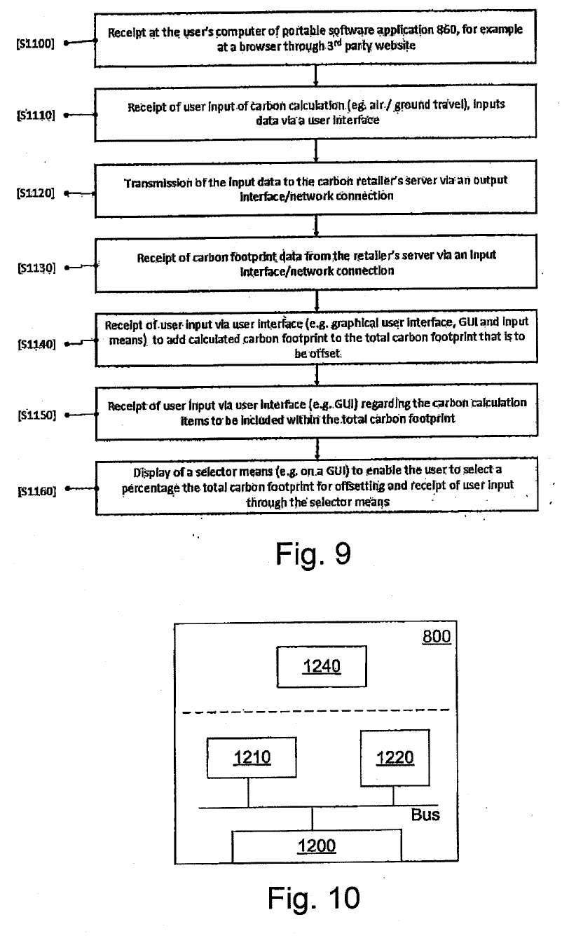

FIG. 9 describes those parts of the above discussed carbon calculation process that are performed in the user's computer 800 in the form of a flowchart. FIG. 10 shows a user's computer capable of implementing the method illustrated in FIG. 9. The process starts at step S1100, at which a software module(s) suitable for implementing parts or all of the above described method is received, for example via network interface 1200 shown in FIG. 10. The software module(s) are temporarily stored in memory 1210, such as cache, for execution by a processor 1220. Such execution may involve the display of the above described user interfaces on a display device 1230 using, in one arrangement a browser 1240. The software module(s) may be received at the user's computer 800 if the user navigates the browser to a website comprising the software module(s), so that the software module(s) are received as part of the website, which may have a purpose that is unrelated to the purpose of the software module(s). It will be appreciated that the software modules(s) have been placed on the website by or on behalf of the carbon retailer.

In the next step, S1110, the user's selection the type or category of carbon calculation, inputs data and requests carbon calculation data is received via user input devices 1250 and/or 1260, which may, for example, be a mouse and a keyboard. At step S1120 the user's computer sends, using network interface 1200, data to retailer's computer 810, for example for transmission on to the carbon calculation data provider's computer 820. In step 1130 the user's computer receivers the above discussed carbon calculated data from the retailer's computer 810 via the network interface 1200. It will be appreciated that this data may be provided to the carbon retailer's computer 810 by the carbon calculation data provider's computer 820 in the above described manner. The user's computer 800 moreover receives from the user via the user input devices 1250 and/or 1260 information indicating which activities, event or purchases, etc. are to be included in the total carbon footprint for the purpose of offsetting. This information is forwarded by the user's computer 800, using network interface 1200, to the retailer's computer 810 alongside a request for total carbon calculation figures. The retailer's computer 810 may forward this data and the request to the carbon calculation data provider's computer 820 and forward the total carbon calculation figures to the user's computer 800, once received from the carbon calculation data provider's computer 820. Alternatively the retailer's computer 810 may perform the relevant calculations itself, for example based on the figures received previously from the carbon calculation data provider's computer 820. In either case the calculated or received total carbon figure is forwarded to the user's computer 800, received there via the network in interface 1200 and displayed on a display device 1230 using, for example, the software module(s) as displayed by the browser 1240.

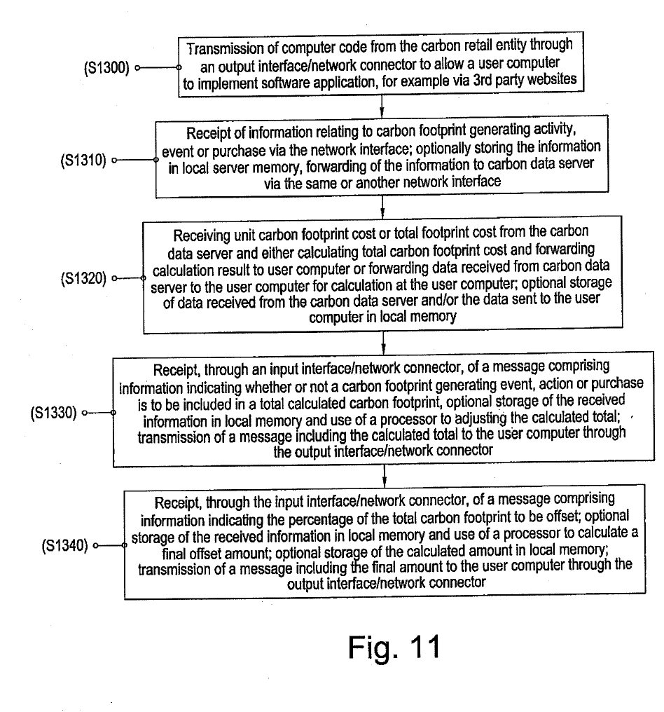

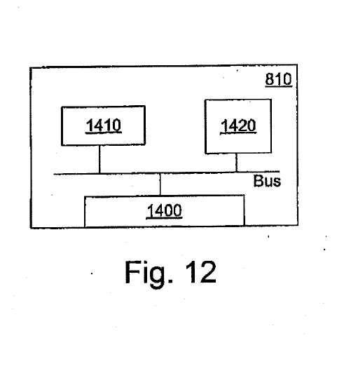

At step S1160 the selector tool 910 is displayed by the software module(s) on the display device 1230, enabling the user to select a percentage of the total carbon value that is to be offset. This percentage value can be input by the user using user input devices 1250 and/or 1260 and are received at the user's computer 800 in this manner. FIG. 11 describes, by way of a flowchart, those parts of the above discussed carbon calculation process that are performed in the retailer's server 810 according to one embodiment. FIG. 12 carbon retailer's server capable of implementing the method illustrated in FIG. 9. In step S1300 the carbon retailer's server/computer 810 makes the computer module(s) required by the user's computer 800 for executing some or all of the above described method available to the user's computer, for example by allowing the software module(s) inclusion on a 3^{rd} party website. It will be appreciated that this step can take place a considerable amount of time before the execution of the below described subsequent steps, as the subsequent steps depend on the user's input.

In step S1310 the carbon retailer's server/computer 810 receives, from the user's computer 800 via a network interface 1400, the data input by a user to identify and quantify the activities, events and purchases etc. for which carbon units are to be purchased. This data may be stored in a memory 1410 before or after it has been forwarded to the carbon calculation data provider's computer 820. A response from the carbon calculation data provider's computer 820 is subsequently received in step S1320, again via the network interface. This data may be unit carbon footprint cost, as indicated in FIG. 11, or alternatively a number indicating the total carbon cost of the event, activity and/or purchase. The received number may be stored in memory 1410 before or after being forwarded to the user's computer 800 for display or to form the basis for further calculations. If the data received from the carbon calculation data provider's computer 820 is unit consumption data, then the microprocessor 1420 of the carbon retailer's computer 810 may use the received unit cost and the previously received data quantifying the activity, event and/or purchase etc. to calculate the total carbon costs of the activity, even and/or purchase. The so calculated number may then be forwarded to the user's computer using the network interface 1400.

In step S1330 the carbon retailer's computer receives a message through the network interface from the user's computer 800 indicating whether or not a carbon footprint generating event, action or purchase is to be included in a total calculated carbon footprint. This information may be storage in the memory 1410. The processor 1420 may adjust the calculated carbon total, optionally store the adjusted total in the memory 1410 and transmit the adjusted total to the user's computer 800 via the network interface 1400. Alternatively the information received from the user's computer 800 may be forwarded to the carbon calculation data provider's computer 820 and the adjustment of the calculated carbon total may be performed by the carbon calculation data provider's computer 820. In this case, the retailer's computer 810 merely servers as a conduit for forwarding the adjusted total to the user's computer and for optionally storing the adjusted total. In step S1340 the percentage of the total calculated carbon footprint that is to be offset is calculated in the same fashion as the above described adjustment.

Returning to FIGS. 8A to F and with particular reference to FIG. 8A, once the number of carbon units that are to be purchased has been determined the carbon unit calculation software tool 870 terminates and the carbon offset project selector tool 870 can be started, either automatically, or manually by the user. FIG. 8E shows a display that may be displayed as part of the software tool 870. As can be seen, several selector icons 920 allowing the user to select a type of carbon offset project, such as for example community, industrial, renewable energy and forestry projects. The software tool 870 receives the relevant information on the types of projects to choose from the carbon retailer's computer 810, which in turn receives the relevant information from one or more carbon project developer's server, one of which is indicated by reference number 830 in FIG. 8E. By relying on a sever separate from the carbon retailer's computer 810 the system can provide up to date information by simply linking to desired project developers. The number of carbon units to be offset is either received by the software tool 870 from the carbon retailer's computer 820, or retrieved from a local memory if the previously active software tool 860 has stored the relevant information there.

The software tool 870 is moreover arranged to display a number of carbon offset projects available within the selected project type. The information required for this display is, again, received at the user's computer 800 from the project developer's computer 830 via the retailer's computer 810. The display may be arranged in the manner shown in FIG. 8E, to display a limited number of the available projects at the time so that sufficient information (such a text, images, video and other multimedia information) can be displayed for the user to be adequately informed of the nature of the project. The software tool 870 may be arranged for easy navigation between different projects.

The software tool 870 also provides an input field 930 through which the user can input the number of carbon units he or she wants to purchase from a particular selected carbon project. In this manner the user can easily choose to purchase the desired carbon units from a number of different projects and can apportion different numbers of units to different projects.

Once the user has chosen one or more carbon offset projects and has associated with each project a number of carbon units that are to be purchased from the offset, the user can choose, through the selection of a purchase icon, to progress the software tool 870 to a purchase screen, such as the screen shown in FIG. 8F. Part of this screen may provide a summary of the projects and number of credits selected and may provide an opportunity to remove projects or alter the number of credits associated with particular projects (this option is not shown in the figures), similar to the screen provided by the carbon calculator software tool 860 and shown in FIG. 8C. The information displayed on such a summary screen is provided by the carbon retailer's computer 810.

As a final step the user's computer 800 receives an indication from the user that the selection made is complete through the activation of the purchase icon 940. Following the activation of this icon 840, the user computer 800 sends a completion message indicating the activation of the icon 840 together with information detailing all the selected projects and the associated number of carbon units to the retailer's computer 810. It will of course be appreciated that the sending of project and carbon credit summary data is only necessary if this data is not already held at the retailer's computer 810. Should this data be held at the retailer's computer 810, then the summary data transmission can be omitted. Once the retailer's computer receives the completion message, the retailer's computer contacts the payment server 850, so that the payment server 850 can debit the amount due for the purchase of the selected carbon units from a pre-existing user account or through alternative payment means in a known fashion.

Once the payment computer 850 has received payment it acknowledges receipt of the payment by sending a message to this effect to the retailer's computer 810. The retailer's computer then communicates with the carbon project developer's computer by sending a message indicating the number of carbon units that are to be retired for each chosen project. The project developer's computer 830 in turn sends a message to the carbon registry 840 requesting the retiring of the appropriate number of carbon units from the selected projects. The registry may respond with a confirmation message, which may comprise unique IDs of the retired units for confirmation purposes and for forwarding to the user's computer.

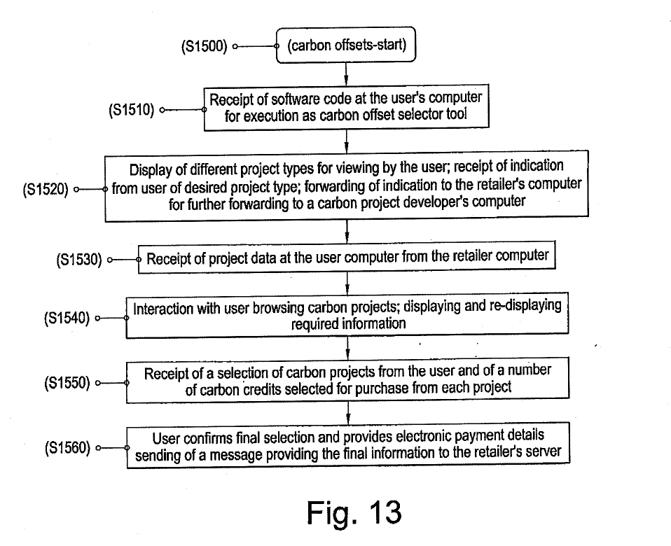

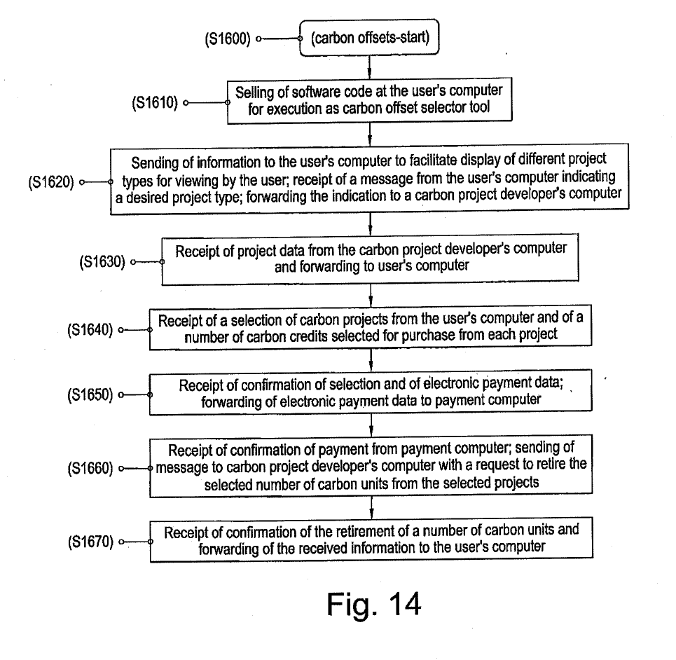

FIGS. 13 and 14 provide details of the steps taken at the user's computer and at the retailer's computer respectively when the above described carbon offset selection routine associated with software tool 870 is executed.

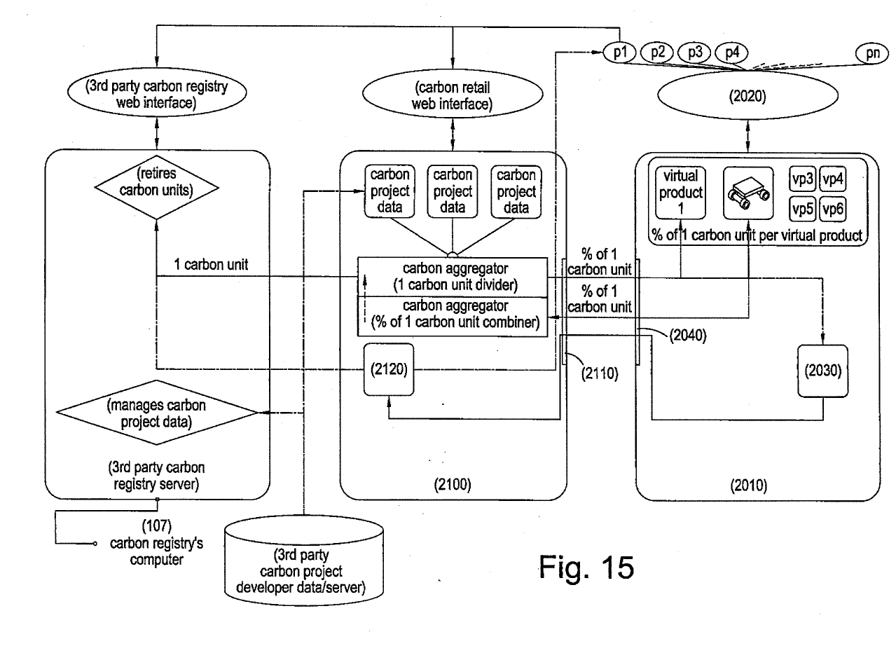

Turning to another embodiment, FIGS. 15 illustrates a system 2000 in which the players of a virtual game are enabled to purchase carbon units or fraction thereof as part of the virtual game and at an in game cost affordable to the individual players. This helps raising awareness of the carbon footprint associated with purchases or actions in the real world and moreover helps to indirectly offset the carbon footprint of the computers and servers operate in running the virtual game.

The system 2000 comprises a server 2010 making the virtual game available to a plurality of players/player computers p1 to pn using a web interface 2020 in a known manner.

Within the virtual environment generated by the virtual game the players can perform action, participate in events and/or make purchases that have a carbon cost attributed with them. A player may, for example, use his or her avatar to visit a virtual shop and purchase one or more items that, as part of the item's cost include a cost for the purchase of a fraction of a (real world) carbon unit. An event or activity the player participates may equally be associated with the purchase of fractions of carbon units. It can, for example, be envisaged that the player may direct his or her avatar to participate in an event or activity that attracts an entry fee, wherein part of this entry fee is used for the purchase of fractions of real world carbon units. It is equally envisaged that the player may have his or her avatar perform a function that attracts income for the avatar, wherein part of that income is redirected, either automatically/compulsorily (for example in a situation where the performed function, had it been performed in the real world, would have a created carbon emissions that could have been offset using purchased carbon credits) to the purchase of fractions of (real world) carbon units.

Different products available in a virtual shop may have different fractions of a carbon unit associated with them, for example in a manner that reflects the carbon footprint a corresponding real world product would have. Alternatively all of the products in a virtual shop may have the same carbon footprint associated with them.

Virtual moneys used as part of virtual games can be ‘purchased’ from the operator of the virtual game. Payment mechanisms for this purpose are known, where players transmit an amount of real world currency to the game operator and receive in exchange virtual currency. It is to be noted that the virtual currency normally has a higher buying virtual power than its real world equivalent, so that purchases and participation in fee attracting events and activities are at a level of affordability that do not impair the players enjoyment of the virtual game. For this reason the purchase of fractions of real world carbon units is enabled in the embodiment, as putting an obligation on players to purchase a full carbon unit every time a carbon unit attracting purchase, activity or event occur may make the purchase of carbon units unattractive or even unaffordable. The games server 2010 comprises a user data store 2030 tracking the level of the user's virtual funds. Although the game sever 2010 is shown to comprise the data store 2030, the data store 2030 may alternatively be provided at an external device that is accessible by the games server 2010, for example via known interface.

The system 2000 also comprises a carbon retailer's computer/server 2100. The retailer's computer/server 2100 can communicate with the games server 2010 via interfaces 2040 and 2110 provided in the respective computers for this purpose. It will be appreciated that, in most embodiments these interfaces are network interfaces that enable the retailer's computer/server 2100 to communicate with the games server 2010 via a network, such as the internet. It will moreover be appreciated that the interfaces 2040 and 2110 may be implemented in software, to enable communication between the two computers/servers via hardware network interfaces provided in both computers/servers in any case.

The carbon retailers' computer/server 2100 moreover comprises a memory 2120 in which user data received from the games server 2010 is maintained. In one embodiment the games server 2010 is arranged to send the user data of a player that has made a purchase or taken part in activity or event that causes the purchase of a fraction of a carbon unit to the carbon retailer's server 2100. The carbon retailer's server 2100 is arranged to contact the player using these user data following receipt of the user data. Such contact may be made, for example, via email. It will be appreciated that any such contact between the player and the carbon retailer does not need to be via the game server 2010 and can instead be a more direct contact that bypasses the games server. The purchase of carbon units by a player from the retailer may therefore be in effect according to the example discussed above with reference to FIGS. 8A to F, albeit without the need for the player to enter the carbon unit generating event or to go to go through a payment exercise as both these elements of the process may be performed via the game server 2010.

The message sent to the player may invite the player to select a carbon project or carbon projects from which one or more fraction of carbon units are to be purchased. This selection process is as described above with reference to FIGS. 8A to F and will not be described in detail again at this stage. Should the player not follow the invitation, then an automatic allocation of the purchased fractions of carbon units may be performed, for example based on a carbon project preferred by the retailer (for example to make up a full carbon unit using the fraction and enable the retiring of the full carbon unit) or on a list of projects agreed between the game server's operator and the carbon retailer. Other selection criteria may also be applied.

When the games server 2010 purchases a fraction of a carbon unit from the carbon retailer on behalf of a player the games server 2010 also provides payment for the carbon unit to the carbon retailer's server 2100. This payment can be made either in real currency or in virtual currency. If the payment is made in real currency, the games server deducts the relevant amount of virtual currency from the player's account, changes it into real world currency and makes the relevant payment to the carbon retailer in a known manner.

It will be appreciated that, if the player is required to select a carbon project the actual cost of the fraction of the carbon unit may not be known when the games server 2010 notifies the carbon retailer's sever 2100 of the purchase of the fraction of the carbon unit. In this case payment may only be made following selection of one or more carbon projects by the user or, in the absence of a timely selection, following an automatic selection.

To expedite the payment process the carbon retailer's server may alternatively agree a fixed fee per carbon unit. This fixed fee may, for example, be based on the average or median cost of a carbon unit calculated from all available carbon projects the user can choose. This average or median cost may also be normalised for the number of carbon units available from the individual projects, so that smaller projects cannot skew the average or median cost unduly. If such a fixed price is agreed upon, the carbon retailer may limit the project the carbon retailer's computer 2100 makes available to the players for selection, so that the player cannot select projects that would cause the carbon retailer to incur costs in purchasing the carbon units from the carbon project developer that exceed the agreed fixed price or that exceed the agreed fixed price minus a profit margin reserved for the retailer. When the projects made available to the user is so limited, the carbon retailer's server 2100 may transmit information regarding the individual projects to the player's computers omitting the costs of the carbon unit. This will put the player in a position to choose a carbon project based solely on the projects perceived merits and untainted by personal economic considerations.

The carbon retailer's server 2100 notifies the games server 2010 of completion of a purchase of a fraction of a carbon unit. The games server 2010 can be arranged to locally store such notification messages and to advise the players at appropriate points in the game of the number or fractions of carbon units that have been retired.

A number of players may play in a group, also known as a guild. The notification to the players may comprise information of the number or fractions of carbon units each player of a guild has purchased and/or the number or fractions of carbon units the entire guild has purchased and/or retired. Such notifications can increase the enjoyment players get out of the game and further helps to promote environmental awareness.

It will be appreciated that, while the above description of the embodiment provides an aggregation module within the retailer's computer in an alternative arrangement an aggregation module may be provided in the game server 2010. The game server may be arranged to aggregate fractions of carbon units internally and to only notify the carbon retailer of the purchase of a carbon unit once enough fractions of carbon units have been aggregated to retire one or more carbon units.

It will also be appreciated that, while the above example uses a payment system involving a virtual to real currency conversion routine, payment for the purchased carbon units may alternatively be made by the player directly to the carbon retailer though the direct contact that is in any case established. This option is, however, less preferred as players may not be willing to pay for the carbon units, despite having purchased a corresponding product in the virtual world.

Moreover, while the above example uses direct contact between a player and the carbon retailer to allow the player to choose one or more carbon projects for the retiring of the carbon units, it is also envisaged that the software function delivered to the user's computer 800 in the example discussed above with reference to FIGS. 8A to F may be incorporated in the virtual environment (instead of in the third party website discussed in the above example).

The example described above with respect to FIG. 15 relates to purchases made in a virtual world. In a further embodiment purchases made in the real world via an online shop can be used as a starting point for the purchase of related carbon units. An online shop may, for example, associate each product with a particular number of carbon units or with fractions thereof. The online retailer may transmit the number of carbon units or fraction thereof associated with the purchase made in the same manner as the games server 2010 shown in FIG. 15 informs the carbon retailer's sever of the fraction of carbon unit purchased. The carbon retailer's server may in return inform the online retailer of the costs of the notified fraction of the carbon unit. Alternatively a fixed cost per carbon unit can be agreed between the carbon retailer's server and the online retailer, so that the online retailer can indicate the costs of offsetting carbon for a particular product before customers select the product. If a fixed carbon unit cost is agreed, then the choice of carbon projects to the customer may be limited as described above, so that the carbon retailer can meet his profit margin.

The online retailer may associate the same fraction of carbon units with each product in the online store or with a plurality of different products in the store. This fixed fraction may reflect the average fraction of a carbon unit of the items in the store or may alternatively be unrelated to the carbon footprint of the items in store.

The online retailer may also forward customer data to the carbon retail server to enable the carbon retail server to contact the customer directly so that the customer can select a desired carbon project, for example in the manner described above with respect to the example shown in FIG. 15. Alternatively, the online shop may permit the carbon retail computer to provide the software function discussed above with respect to FIGS. 8A to F for selecting the carbon project, so that customer data does not have to be forwarded to the carbon retailer's server. Notifications of retired carbon units can be forwarded to the online retailer's server and from there on to the online customer, either as part of the purchasing process or at a later stage once a full carbon unit including a fraction associated with a particular purchase has been retired.

The example described above with reference to FIGS. 8A to F refers to 3^{rd} party websites that allow execution of the software functions provided by the carbon retail server. These software functions may be unrelated to the other content of the 3^{rd} party website or, as in the above described online retail example, related with this other content. It will be appreciated that, while the above described online retail example referred to the sale of products, the sale of services is also encompassed by this example. This includes services that are regularly or frequently rendered. One example of such a service is the provision of communication services, such as mobile telephone calls, a short messaging services and the like. It will be appreciated that it is not practical, nor desirable, for a communications user to be contacted with a request to choose a carbon project every time a communication service is used, for example every time a telephone call is placed or a short/‘text’ message is sent. It is already the case that a mobile communications provider accumulates data of each instance a communication service is used for billing purpose. In one embodiment the server of the communication service provider is arranged to communicate such cumulative data to a carbon retail server, for example in the same manner as described above with respect to the games server. The carbon retail server can then contact the communication service user with the above described request to select a carbon project or carbon projects from which carbon units are to be purchased. Payment for the purchased carbon units can either be made directly from the communication services user to the carbon retailer. Alternatively the costs of the fraction of the carbon unit may be included in the communication service provider's charges to the communication service user and the appropriate part of these total charges can then be forwarded by the communication service provider to the carbon retailer.

While the invention has been described in terms of what are at present its preferred embodiments, it will be apparent to those skilled in the art that various changes can be made to the preferred embodiments without departing from the scope of the invention, which is defined by the claims.

1. A computing device comprising an input, a memory, a processor and an output, the input operational to receive information of fractions of a carbon units that are to be purchased, the memory operational to store the received information and the processor operational to sum the stored fractions and to provide an output when the sum has reached an integer requesting the retiring of a number of carbon units, the number being the same as the integer.

2. The computing device of claim 1, the processor further arranged to return a fraction of the sum exceeding the integer to the memory for storage therein as a starting point for a next sum for the retiring of a next carbon unit.

3. The computing device of claim 1, wherein the information further comprises an indication of an association of the fraction with a predetermined carbon project from which the fraction is to be retired;
wherein the processor is arranged to calculate individual sums of all fractions stored for a particular carbon project and to generate an output for a specific carbon project once the sum for the carbon project has reached an integer.

4. The computing device of claim 1, wherein the computing device is a server comprising a network connection for communicating with a user's computer via a network.

5. The computing device of claim 1, further arranged to cause software code to be provided to users' computers for execution thereon to enable an interaction with the computing device.

6. The computing device of claim 5, wherein the software code comprises one or more of a carbon unit calculation module or a carbon project selector tool.

7. The computing device of claim 6, wherein the carbon unit calculation module is operative to, when executed on a user's computer, display a determined total carbon footprint associated with at least one of an event, activity or purchase, to provide an input for enabling the user to select a portion of the footprint for which carbon unit are to be purchased an input for receiving an indication of the user of a selected portion and an output for informing the computing device of the received indication.

8. The computing device of claim 6, further arranged to output carbon project information for receipt by a user's computer and for use by the carbon project selector tool.

9. The computing device of claim 8, further arranged to receive the carbon project information from one or more carbon project developer's computers and to forward at least a portion of the received information to a user's computer.

10. The computing device of claim 1, further arranged to receive, via an input information detailing one or more of an event, a purchase or an activity with which a carbon footprint is associated, wherein the device further comprises a carbon unit determiner arranged to determine the number of carbon units and fractions thereof that are associated with the event, purchase or activity, based on the received information.

11. The computing device of claim 10, wherein the carbon unit determiner comprises an output for forwarding the information to a carbon unit calculator and an input for receiving information regarding the calculated number of carbon units and fractions thereof.

12. A computing device comprising a memory and a processor, the memory storing software code arranged to, when executed by the processor, create a virtual environment and to at least one of:
provide, within this virtual environment at least one of an activity or event with which a carbon footprint has been associated, or
offer for purchase a product with which a carbon footprint has been associated;
the device arranged to receive an indication provided within the virtual world of one or more of a participation in a said event or activity or purchase of a said product, to retain said indication or an associated carbon footprint within a memory and to use an output to provide to a real world computing device information of the carbon footprint created in the virtual world.

13. The computing device of claim 12, wherein the computing device is a games server comprising one or more network interface through which player computers can interact with the computing device to participate in the virtual environment, wherein the computing device is arranged to receive messages comprising said indication from player computers via a said network interface.

14. A web server arranged to provide an online store on a network and to display for purchase one or more goods or services based on information stored in a memory of the server, wherein as part of the information a carbon value is associated with each of the goods or services, wherein the processor is arranged to send a message to a further computing device indicating the carbon value associated with a purchased good or service and requesting that a carbon unit corresponding to the associated carbon value be retired.

15. A web server according to claim 14, wherein said carbon values can be non-integer values and wherein the processor is arranged to accumulate fraction of carbon units until an accumulated sum is such that retiring of an integer number of carbon units can be requested.

16. A carbon credit trading system, comprising a server having
an input for receiving information indicating a user's carbon usage;
a payment calculator module comprising a processor and memory, the memory configured to receive the information from the input, the processor operable to calculate and output a value indicating a cost of a selected portion of the user's carbon usage,
an output for sending said calculated value to the user for approval;
a user input for receiving approval of the calculated value or receiving further information from the user indicating an alternative selected proportion of the carbon usage that the user will pay; and
a payment module for initiating billing of the user after receiving the user's approval.

17. The carbon credit trading system of claim 16, further comprising a carbon unit calculator for requesting user information relating to at least one activity or product having an associated carbon footprint, the calculator being configured to calculate a quantity of carbon units associated with said at least one activity or product.

18. The carbon credit trading system of claim 16, wherein the further information from the user comprises a percentage value of the carbon usage.

19. The carbon credit trading system of claim 16, wherein the payment calculator module is configured to input a value indicating a proportion or amount of the cost paid for by a corporate contribution, and to calculate a user payment value accordingly, and wherein the payment module is further configured to bill the corporate contribution to a corporate account.

20. The carbon credit trading system of claim 19, wherein the proportion or amount of the cost paid for by a corporate contribution is configured as being dependent on the calculated value approved by the user.

21. A carbon credit trading system comprising
a carbon credit vending module for selling fractional parts of carbon credits associated with other real or virtual products;
a carbon credit aggregation module for keeping track of the fractional parts of carbon units sold to different entities, and for retiring carbon credits when a whole number of carbon credits has been accumulated;
wherein the vending module is configured to provide a code module, enabling redistribution of fractional parts of a carbon credit, to an entity purchasing carbon credits or fractions of carbon credits, so that aggregation of carbon credits occurs on multiple systems.

22. The carbon credit trading system of claim 21, wherein the vending module is configured to require entities to purchase a larger fraction or amount of carbon units in order to be provided with said code module, than entities that are not provided with the code module.

23. The carbon credit trading system of claim 22, wherein the code module is configured to enable an entity selling more carbon units than they purchase to keep at least a proportion of the profit.

24. The carbon credit trading system of claim 22, wherein the code module is configured so that if an entity sells more carbon units than they purchase, at least a proportion of the extra money is used to automatically purchase additional carbon units or carbon unit fractions.

25. A carbon credit trading system comprising a computer running a virtual store interface for a virtual reality environment, the computer comprising a processor and memory configured to link virtual products with fractions of carbon credits, and to buy or sell the carbon credits with the virtual products using a real currency or a currency specific to the virtual reality environment.

26. A carrier medium carrying computer readable code for controlling a computer as the system claimed in claim 16.

27. A carrier medium carrying computer readable code for controlling a computer as the system claimed in claim 21.

28. A carrier medium carrying computer readable code for controlling a computer as the system claimed in claim 25.
